(19) United States
(12) Patent Application Publication
(10) Pub. No.: US 2017/0345010 A1
(43) Pub. Date: Nov. 30, 2017

(54) SALES ASSISTANCE METHOD AND SALES ASSISTANCE SYSTEM

(71) Applicant: Panasonic Intellectual Property Management Co., Ltd., Osaka (JP)

(72) Inventors: Akira HAGIHARA, Tokyo (JP); Takeshi WAKAKO, Kanagawa (JP); Sako KONDO, Osaka (JP)

(21) Appl. No.: 15/676,335

(22) Filed: Aug. 14, 2017

Related U.S. Application Data
(63) Continuation of application No. PCT/JP2016/003645, filed on Aug. 8, 2016.

(30) Foreign Application Priority Data
Sep. 17, 2015 (JP) 2015-183960

(51) Int. Cl. G06Q 20/40

(52) U.S. Cl. CPC G06Q 20/40145

(57) ABSTRACT

A sales support method and. a sales support system which can reduce time and effort of a customer due to age verification when sales of age-restricted merchandise are performed. Age estimation information that is information obtained by estimating an age of a customer by using biometric information obtained by observing the customer is acquired, information that is input by the customer is acquired as age information of the customer in a case where the age estimation information is greater than or equal to a second predetermined age, and information based on a medium that the customer possesses is acquired as the age information of the customer in a case where the age estimation information is less than the second predetermined age, and whether the customer is older than or equal to a first predetermined age or under the first predetermined age is determined based on the age information of the customer and the determination result is notified.

### BACKGROUND

### 1. Technical Field

The present disclosure relates to a sales support method and a sales support system which support sales of age-restricted merchandise.

### 2. Description of the Related Art

When sales of age-restricted merchandise such as alcohol beverages or tobacco are performed, an age of a customer which intends to purchase merchandise needs to be verified, and the sales needs to be performed. after obtaining verification that age restrictions are met. Related art proposes various techniques as a device which supports sales of the age-restricted merchandise (for example, PTL 1).

In PTL1, a customer which purchases age-restricted merchandise is request to declare his or her age and, in a case where the declared age exceeds restricted age verification is performed by an age certificate such as a driver's license or a health insurance card. Thereby, as accurate age verification is performed, unjust age reporting is prevented and age verification of a customer which intends to purchase age-restricted merchandise is facilitated.

### CITATION LIST

### Patent Literature

PTL 1: Japanese Patent Unexamined Publication No. 2014-2686.

### SUMMARY

A sales support method according to the present disclosure is a sales support method which supports sales of age-restricted merchandise including: acquiring age estimation information that is information which is obtained by estimating an age of a customer by using biometric information which is obtained by observing the customer; acquiring information that is input by the customer as age information the customer in a case where the age estimation information is greater than or equal to a second predetermined age, and acquiring information based on a medium that the customer possesses as the age information of the customer in a case where the age estimation information is less than the second predetermined age; and determining whether the customer is older than or equal to a first predetermined age or under the first predetermined age, based on the age information of the customer and notifying the determination result.

In addition, a sales support system according to the present disclosure is a sales support system which supports sales of age-restricted merchandise including: an input unit for putting whether a customer is older than or equal to a first predetermined age or under the first predetermined age; an age estimation unit that estimates an age by using biometric information which is obtained by observing the customer; a determination unit that acquires age information of the customer on the basis of the age estimation information and determines whether the customer is older than or equal to the first predetermined age or under the first predetermined age on the basis of the age information of the customer; and a notification unit that notifies determination result of the determination unit, in which the determination unit acquires information that is input by the customer as age information of the customer in a case where the age estimation information is greater than or equal to a second predetermined age, and acquires the age information of the customer on the basis of a medium that the customer possesses in a case where the age estimation information is less than the second predetermined age.

A sales support method and a sales support system according to the present disclosure can reduce time and effort of a customer due to age verification when sales of age-restricted merchandise are performed.

### BRIEF DESCRIPTION OF THE DRAWINGS

FIG. 1 is a diagram illustrating an example of a layout of a store in which a sales support system according to one exemplary embodiment is installed.

FIG. 2 is a diagram illustrating a sales support terminal installed in each of aisles illustrated in FIG. 1.

FIG. 3 is a block diagram illustrating a detailed configuration of a store server illustrated in FIG. 1 and the sales support terminal illustrated in FIG. 2.

FIG. 4 is a flowchart illustrating an operation of the sales support system according to the exemplary embodiment.

FIG. 5A is a communication sequence diagram illustrating an example of the operation of the sales support system according to the exemplary embodiment.

FIG. 5B is a communication sequence diagram illustrating another example of the operation of the sales support system according to the exemplary embodiment.

FIG. 5C is a communication sequence diagram illustrating still another example of the operation of the sales support system according to the exemplary embodiment.

FIG. 5D is a communication sequence diagram illustrating still another example of the operation of the sales support system according to the exemplary embodiment.

FIG. 6A is one diagram illustrating a display example of an image for age verification performed by a touch panel display.

FIG. 6B is another diagram illustrating the display example of the image for age verification performed by the touch panel display.

FIG. 7 is a block diagram illustrating a detailed configuration of a sales support system according to another exemplary embodiment.

FIG. 8 is a communication sequence diagram illustrating an example of an operation of the sales support system according to another exemplary embodiment.

FIG. 9 is a communication sequence diagram illustrating an example of the operation of the sales support system according to another exemplary embodiment.

FIG. 10A is a diagram illustrating one display example of a determination result obtained by a determination unit in a display of a POS register.

FIG. 10B is a diagram illustrating another display example of a determination result obtained by the determination unit in the display of the POS register.

### DETAILED DESCRIPTION

Hereinafter, exemplary embodiments will be described in detail with reference to suitable drawings. However, detailed description more than necessary may be omitted. For example, detailed description on well-known matters or repeated description on substantially the same configuration may be omitted. This is for avoiding unnecessary redundancy of the following description and for a person skilled in the art to easily understand.

The accompanying drawings and description are used to let a person skilled in the art sufficiently understand the present disclosure, and these are not intended to limit the subject matter described in the scope of Claims. That is, all the exemplary embodiments which will be described hereinafter show one specific example of the present disclosure. Numerical values, shapes, materials, configuration elements, disposed positions and connection forms of the configuration elements, steps, the sequence of steps, and the like described in the following exemplary embodiments are an example, and are not the purpose of limiting the present disclosure. In addition, configuration elements which are not described in independent claims representing top level concept, among the configuration elements of the following exemplary embodiments, are described as optional configuration elements.

### Exemplary Embodiment

Hereinafter, first exemplary embodiment is described with reference to the drawings.

### [1. Configuration]

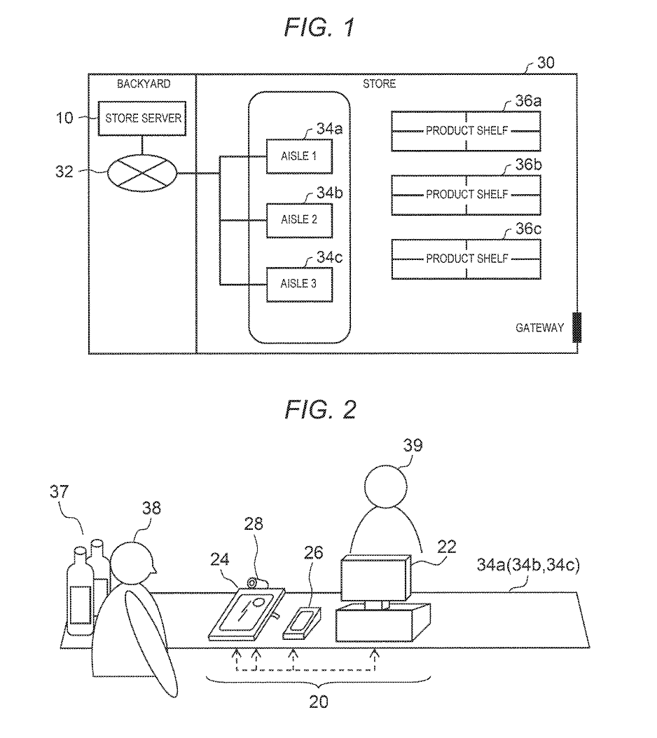

FIG. 1 is a diagram illustrating an example of a layout of store 30 in which a sales support system according to one exemplary embodiment is installed. Product shelves 36a to 36c on which various types of merchandise including age-restricted merchandise are displayed, aisles 34a to 34c for paying purchased merchandise, sales support terminals (not illustrated) installed in each of aisles 34a to 34c, and store server 10 installed in a backyard connected to communication network 32 are provided in store 30. Store server 10 is an example of a sales support device which supports sales of age-restricted merchandise, is provided in each store, and is, for example, a computer device. Store server 10 may also serve as a server of a point of sales (POS) system, and may be connected to an external computer device such as a cloud server through a communication network such as the Internet.

FIG. 2 is a diagram illustrating sales support terminal 20 installed in each (here, aisle 34a) of aisles 34a to 34c illustrated in FIG. 1. Here, a state where a customer 38 who purchases age-restricted merchandise 37 such as alcoholic beverage pays in aisle 34a that store clerk 39 is responsible for. Sales support terminal 20 is an example of a sales support terminal which supports sales of the age-restricted merchandise, and includes POS register 22, touch panel display 24, ID scanner 26, and camera 28.

POS register 22 is a cash register having terminal function of a POS system. Touch panel display 24 is an example of an input device for age verification and a display device. The input device is the device to which whether customer 38 is older than or equal to a first predetermined age or under the first predetermined age (whether or not the customer is older than or equal to the first predetermined age) is input, and is, for example, a tablet PC which serves as an input device and a display device, or the like. ID scanner 26 reads information from a medium (for example, ID card) that a customer has, and is, for example, a bar-code reader, a magnetic card reader, an IC card reader, or the like. Camera 28 is an example of a device which acquires biometric information obtained by observing a customer, and is a digital camera which acquires an image of the customer as the biometric information, or the like. In the present exemplary embodiment, touch panel display 24 and camera 28 are configured as one piece as a tablet PC. Camera 28 is incorporated into an upper portion of touch panel display 24.

In addition, in a case where surrounding brightness is insufficient in estimating age, the surrounding brightness may be secured by increasing the amount of back light of touch panel display 24 (for example, tablet PC).

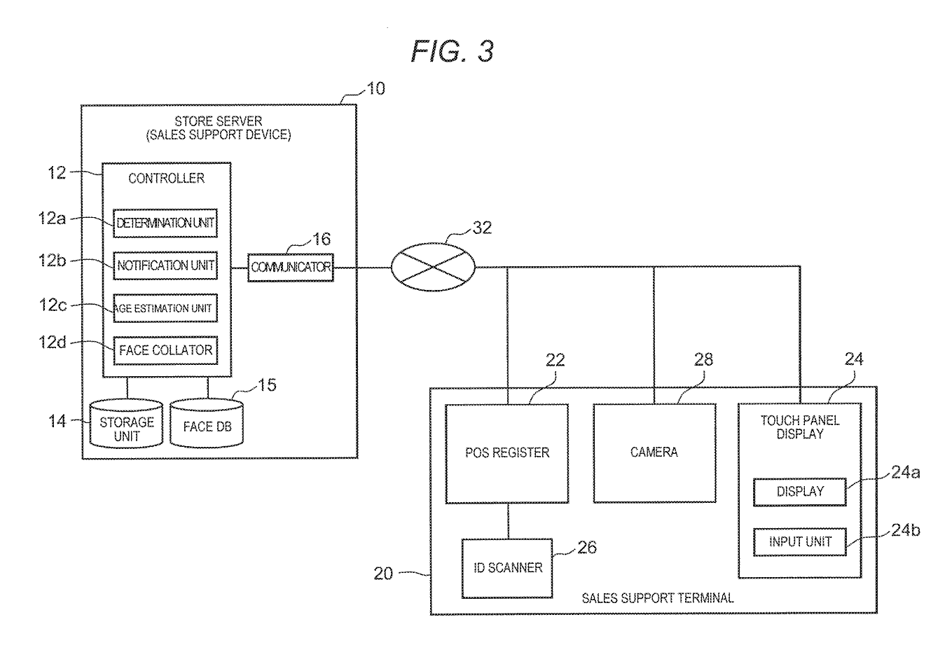

FIG. 3 is a block diagram illustrating a detailed configuration of store server 10 illustrated in FIG. 1 and sales support terminal 20 illustrated in FIG. 2. The sales support system which supports sales of age-restricted merchandise is configured by store server 10 and sales support terminal 20 that are an example of a sales support device.

Sales support terminal 20 includes POS register 22, touch panel display 24, ID scanner 26, and camera 28. Here, ID scanner 26 is connected to POS register 22, and POS register 22, camera 28, and touch panel display 24 are connected to store server 10 through communication network 32.

POS register 22 includes a sensor (not illustrated) which reads bar-code information attached to merchandise, and includes a display (not illustrated) which displays the read bar-code information or the like.

Camera 28 is an image capturing device, and transmits an image (that is, face image) obtained by capturing an image of a customer to store server 10.

In the present exemplary embodiment, Touch panel display 24 is controlled by store server 10. Specifically, touch panel display 24 includes display 24a which provides a customer with information, and input unit 24b to which response of the customer is input.

Touch panel display 24 receives request from determination unit 12a, displays the purpose that age declaration requires on display 24a, urges customer 38 to input to input unit 24b, that is, acquires declared age (age information of customer) indicating whether customer 38 is older than or equal to the first predetermined age or customer 38 is under the first predetermined age from customer 38 through conversation with customer 38, and transmits the acquired declared age to store server 10. Information input to input unit 24b may be information indicating that an input on whether or not customer 38 is older than or equal to the first predetermined age is refused (customer refused to answer) in addition to the above description.

Here, the age-restricted merchandise is merchandise which is restricted to be sold to a customer under the first predetermined age, and the first predetermined age is determined depending on a nation, a region, or the like. For example, sales of alcoholic beverage or tobacco to a customer under 20 years old are restricted in Japan.

ID scanner 26 reads information for acquiring age of customer 38 from an ID card that customer 38 possesses, specifies the age of customer 38 from the read information, and transmits actual age (age information of customer) indicating the specified age to store server 10 through POS register 22. In a case where the actual age is recorded in the ID card that customer 38 possesses, ID scanner 26 transmits the read actual age to store server 10 as it is. In a case where the actual age is not recorded in the ID card that customer 38 possesses, ID scanner 26 acquires the actual age recorded in store server 10 or other databases from an ID recorded in the ID card(for example, member ID), and then ID scanner 26 transmits the acquired actual age to store server 10.

Store server 10 is an example of a sales support device that supports sales of age-restricted merchandise, and includes controller 12, storage unit 14, face DB 15, and communicator 16.

Communicator 16 is a communication adapter that communicates with sales support terminal 20 through communication network 32, and acquires input information from touch panel display 24, acquires face image from camera 28, or acquires actual age from ID scanner 26, under control of controller 12 in the present exemplary embodiment.

Storage unit 14 stores processing results of controller 12, and is a nonvolatile memory such as a hard disk.

Face DB 15 is a database in which face feature quantity used for determining whether or not customer 38 is older than or equal to the first predetermined age, and the registered data is face features of a customer older than or equal to the first predetermined age.

Controller 12 is a controller that controls sales support terminal 20 through communicator 16, and includes determination unit 12a, notification unit 12b, age estimation unit 12c, and face collator 12d as a functional processor. These processors are implemented by components such as a memory in which a control program is stored and a processor that executes the control program. The control program is included in controller 12.

Determination unit 12a determines whether or not a customer is older than or equal to the first predetermined age, based on age information of the customer, such as actual age or the like acquired by input unit 24b of touch panel display 24 or ID scanner 26.

In addition, determination unit 12a determines whether customer 38 is older than or equal to a second predetermined age or the customer is under the second predetermined age (whether or not the customer is older than or equal to the second predetermined age) on the basis of age estimation information of age estimation unit 12c, and requests (instructs) touch panel display 24 or ID scanner 26 to acquire the age information of the customer, based on the determination result.

In addition, determination unit 12a determines whether or not customer 38 is older than or equal to the first predetermined age on the basis of the face collation results of face collator 12d.

Here, the second predetermined age may be the same value (age) as the first predetermined age, and may be a value different from the first predetermined age.

Notification unit 12b notifies sales support terminal 20 of the determination result of determination unit 12a. Specifically, in a case where determination unit 12a determines whether or not customer 38 is older than or equal to the first predetermined age, notification, unit 12b transmits the determination result to sales support terminal 20.

Age estimation unit 12c obtains age estimation information in which age of a customer is estimated, using a face image acquired from camera 28 through communicator 16. Age estimation unit 12c is configured by a memory in which a control program is stored, a processor which executes the control program, and the like. For example, processing of estimating age of a customer from a face image of the customer is performed by using a method (for example, Japanese Patent No. 5072102) of learning correspondence between feature quantity extracted from an image of a face whose age is determined in advance and age, and of estimating age from feature quantity extracted from an image of a face whose age is unknown, based on the learned results. In addition, “age” of the customer that performs the estimation is not limited to one numerical value, and may be in a numerical value range (age section) from 15 years old to 18 years old, of 30 years old or more, or the like.

Face collator 12d extracts face feature quantity of the customer, using the face image acquired from camera 28 through communicator 16, and searches whether or not feature quantity coinciding with the face feature quantity is registered in face DB 15. In face DB 15, feature quantity of the customer registered in the past is registered.

### [2. Operation]

Next, an operation of the sales support system (store server 10 and sales support terminal 20), which is configured as described above, according to the present exemplary embodiment will be described.

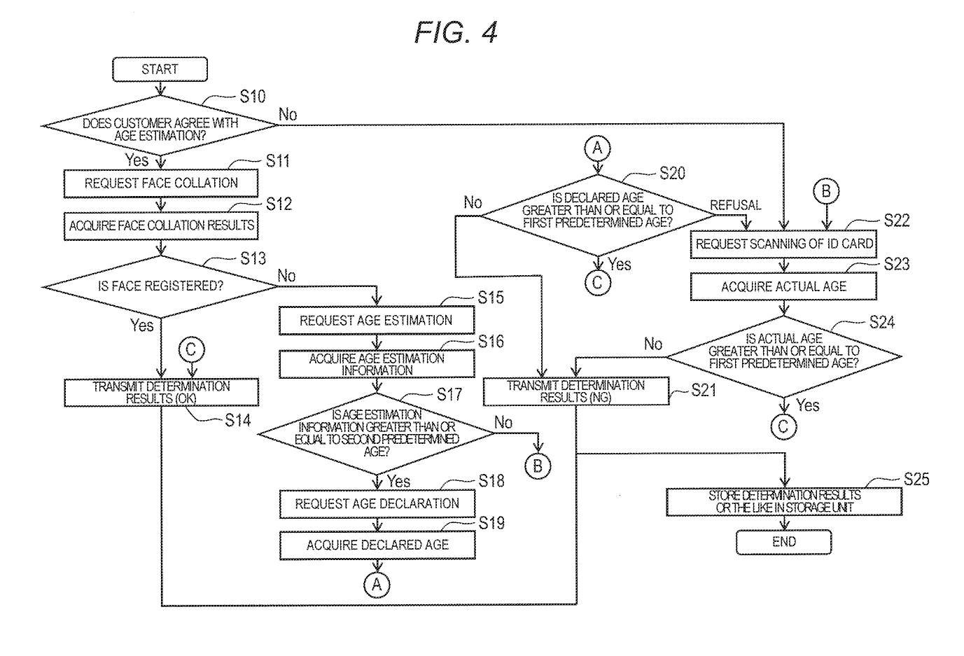

FIG. 4 is a flowchart illustrating an operation (that is, sales support method) of the sales support system (store server 10) according to the exemplary embodiment. Here, a processing flow performed by store server 10 in a case where merchandise to be purchased by customer 38 is proved to be age-restricted merchandise (a customer under a predetermined age is regulated) by POS register 22 (that is, reading of bar-code information given to merchandise) is illustrated. Now, input information indicating whether or not customer 38 agrees with age estimation of camera 28 is obtained by touch panel display 24, the input information is transmitted from touch panel display 24 to store server 10.

As a result, in a case where there is an answer (input) indicating that customer 38 agrees with the age estimation of camera 28 (Yes in S10), determination unit 12a subsequently requests face collator 12d to send collation results indicating whether or not the face feature quantity of customer 38 is registered in face DB 15 (S11).

Face collator 12d determines whether or not there is known registration information coinciding with the face feature quantity of customer 38 in face DB 15.

In a case where the determination result indicate that the face feature quantity of customer 38 is registered in face DB 15 (Yes in S13), determination unit 12a determines customer 38 is older than or equal to the first predetermined age. Notification unit 12b transmits the determination result, that is, OK to POS register 22 of sales support terminal 20 through communicator 16 (S14).

Meanwhile, in step S10, in a case where the input information does not indicate that customer 38 agrees with the age estimation of camera 28 (No in S10), determination unit 12a requests POS register 22 installed in an aisle through which the input information is sent to scan an ID card that customer 38 possesses by using ID scanner 26 through communicator 16 (S22). If the ID card is scanned, determination unit 12a acquires actual age (age information from the ID card) (S23), and determines whether or not the acquired actual age is greater than or equal to the first predetermined age (S24). As a result, in a case where the acquired actual age is greater than or equal to the first predetermined age (Yes in S24), notification unit 12b transmits the determination result to POS register 22 of sales support terminal 20 through communicator 16 (S14). In addition, in a case where the acquired actual age is less than the first predetermined age (No in S24), notification unit 12b transmits the determination result, that is, NG to POS register 22 of sales support terminal 20 through communicator 16 (S21).

In a case where the face feature quantity is not registered in step S13 (No in S13), determination unit 12a requests age estimation unit 12c to perform age estimation (S15), and age estimation unit 12c estimates an age of a customer by using a face image which can be acquired from camera 28. When age estimation information is acquired (S16), determination unit 12a determines whether or not the age estimation information is greater than or equal to the second predetermined age (S17), and in a case where the age estimation information is greater than or equal to the second predetermined age (Yes in 517), determination unit 12a requests touch panel display 24 to perform age declaration (S18). When declared age is acquired (S19), determination unit 12a determines whether or not the declared age is greater than or equal to the first predetermined age (S20), and in a case where the declared age is greater than or equal to the first predetermined age (Yes in S20), determination unit 12a determines that customer 38 is older than or equal to the first predetermined age, and notification unit 12b transmits the determination result to POS register 22 of sales support terminal 20 through communicator 16 (S14). In a case where the declared age is less than the first predetermined age, determination unit 12a determines that customer 38 is under the first predetermined age (No in S20), the notification unit transmits the determination result to POS register 22 of sales support terminal 20 through communicator 16 (S21).

In a case where the age information of the customer indicates that the age is less than the second predetermined age in step S17 (No in S17), the ID card is requested to be scanned by ID scanner 26 (S22). Subsequent steps are the same as the aforementioned steps, and thus, description thereof will be omitted.

After notification unit 12b notifies (S14, S21), determination unit 12a specifies current time on the basis of a timer (not illustrated) that controller 12 includes, and stores the determination result in storage unit 14, and the specified current time (S25).

As such, according to the sales support system (store server 10 and sales support terminal 20) of the present exemplary embodiment, a customer whose age estimation information is less than the second predetermined age is requested to present an ID card without age declaration when sales of age-restricted merchandise are performed. Thereby, the customer for whom double-checking the age declaration and presentation of the ID card is performed can complete age verification in any one of the age declaration and the ID card by introducing store server 10. Face collation (S10, S11, S12, S13) and storage of the determination result (S25) may be appropriately performed.

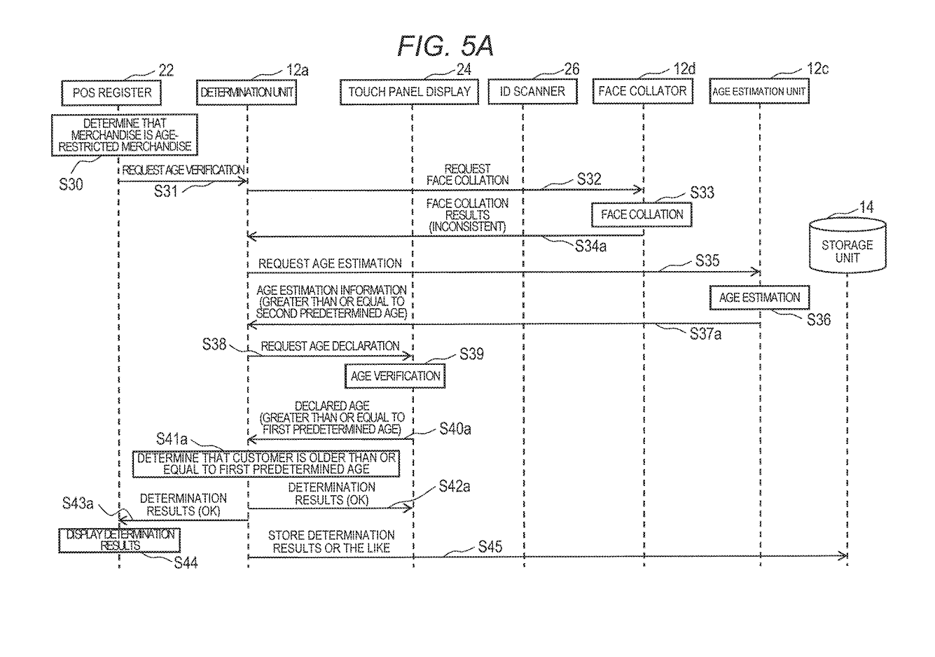

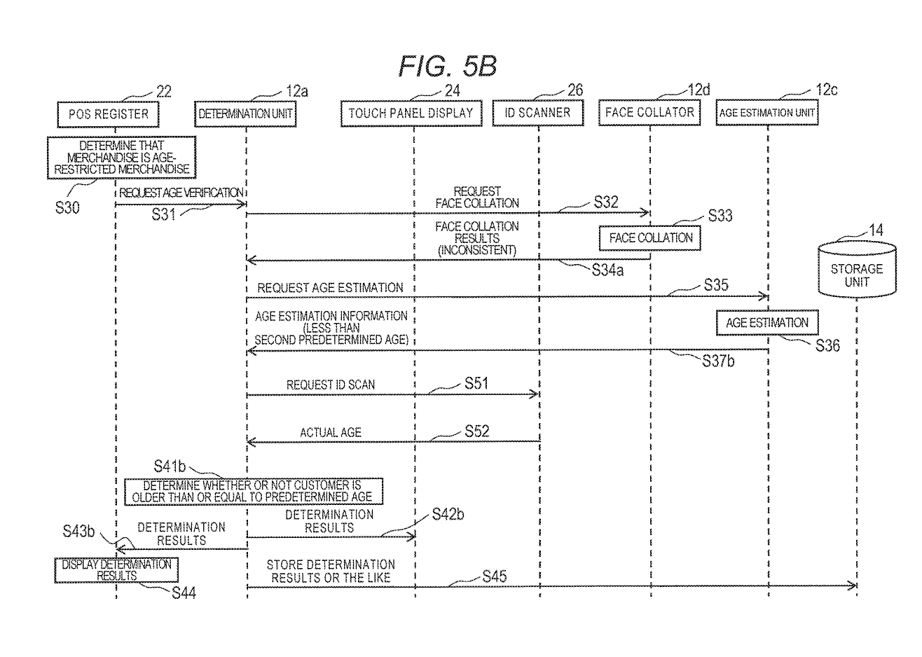

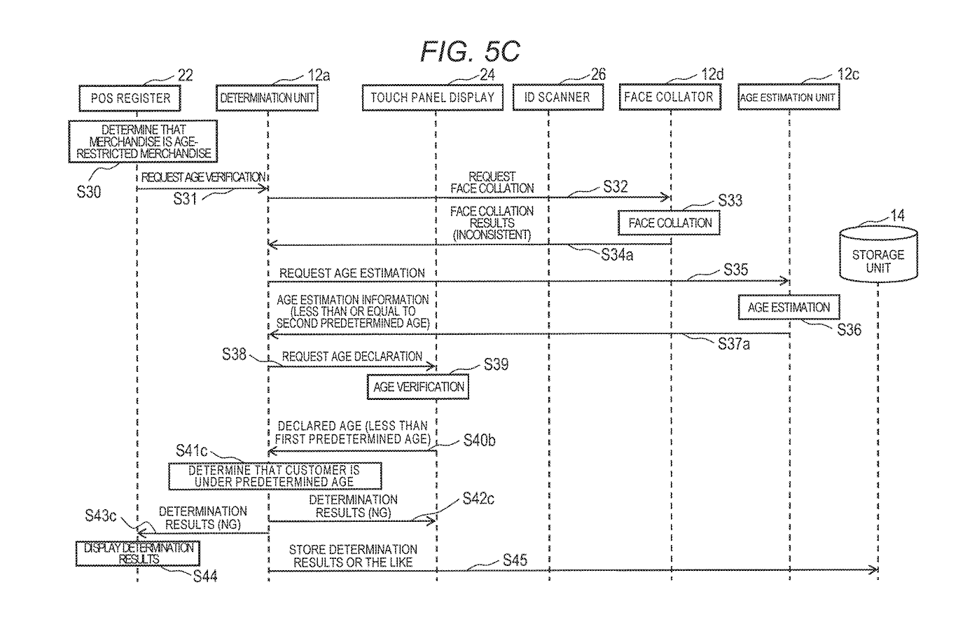

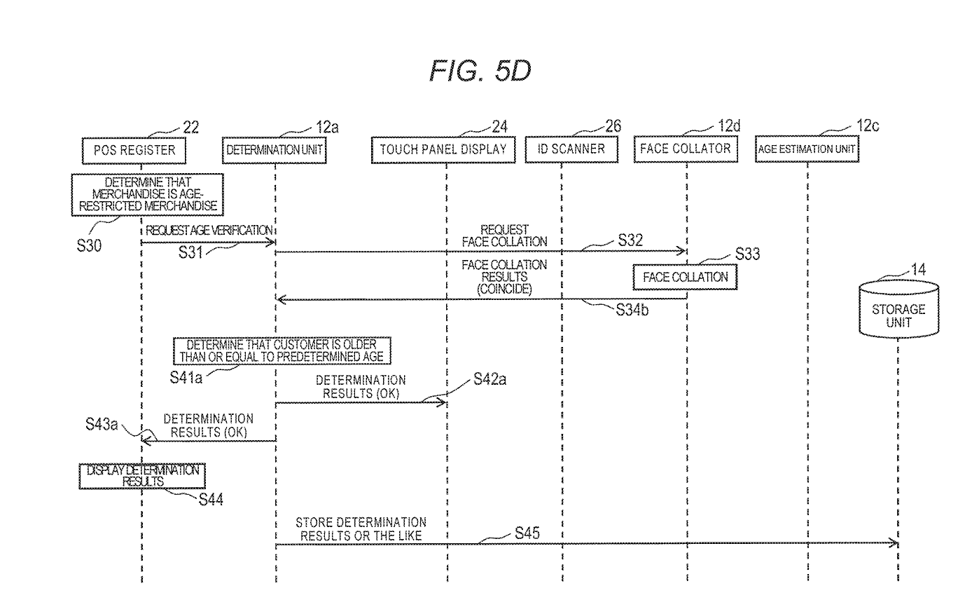

FIG. 5A is a communication sequence diagram illustrating an example of the operation of the sales support system (store server 10 and sales support terminal 20) according to the exemplary embodiment. Processing and communication exchanges of POS register 22, touch panel display 24, ID scanner 26, and determination unit 12a, age estimation unit 12c, face collator 12d, and storage unit 14 of store server 10 are illustrated herein. FIG. 5A illustrates a communication sequence in a case where collation results of customer 38 do not coincide when face collation is performed, age estimation information of the customer is determined to be greater than or equal to the second predetermined age, and there is an answer indicating that customer 38 is older than or equal to the first predetermined age when age declaration is performed. For the sake of brief description, description will be made by assuming that the age estimation of FIG. 4 is agreed.

If a sensor included in POS register 22 reads bar-code information attached to merchandise that customer 38 purchases and determines that the merchandise is age-restricted merchandise (merchandise whose sales to a customer under a predetermined age is regulated) (S30), determination unit 12a is requested to perform age verification (S31).

Determination unit 12a requested to perform the age verification requests face collator 12d to perform face collation (S32).

Face collator 12d receiving request for face collation searches whether or not face feature quantity of customer 38 is registered in face DB 15, using an image (that is, face image) by capturing an image of customer 38 (S33), and determines that there is no coinciding face feature quantity (S34a).

Determination unit 12a acquires the determination result, and requests age estimation unit 12c to perform age estimation (S35).

Age estimation unit 12c requested to perform the age estimation estimates an age of customer 38, using an image (that is, face image) obtained by capturing an image of customer 38 (S36). The face image being used herein may be the same as the face image being used in S33.

Determination unit 12a acquires age estimation information (S37a), and determination unit 12a requests touch panel display 24 to perform age declaration, based on results of the age estimation information (here, greater than or equal to second predetermined age) (S38).

Touch panel display 24 received request for age declaration obtains an answer (input of age greater than or equal to the first predetermined age) for the age declaration (S39), and transmits the declared age (here, greater than or equal to the first predetermined age) to determination unit 12a (S40a).

When acquiring the declared age, determination unit 12a determines that the customer is older than or equal to the first predetermined age by using the information (S41a).

As a determination result of determination unit 12a, that is, purpose which is OK is transmitted to touch panel display 24 (S42a), and the determination result are transmitted to POS register 22 in the same manner (S43a). Touch panel display 24 received the determination result displays the determination result on display 24a of touch panel display 24 and POS register 22 displays the determination result on a display (not illustrated) of POS register 22 (S44). In addition, determination unit 12a specifies current time on the basis of a timer (not illustrated) that controller 12 includes, and stores the determination result or the like (aisle ID, current time, input information, age estimation information, determination result, and the like) in storage unit 14, and the specified current time (S45).

As such, in a case where the age estimation information is determined to be greater than or equal to the second predetermined age, the customer may perform only the age declaration, and thus, it is possible to reduce burden of the customer.

FIG. 5B is a communication sequence diagram illustrating another example of the operation of the sales support system (store server 10 and sales support terminal 20) according to the exemplary embodiment. The present figure illustrates a communication sequence in a case where collation results of customer 38 do not coincide when face collation is performed, and age estimation information of the customer is determined to be less than the second predetermined age. Steps S30 to S36, S44, and S45 are the same as the processing illustrated in FIG. 5A, and thus, the same symbols or reference numerals are attached and description thereof will be omitted.

In a case illustrated in the present figure, age estimation unit 12c estimates an age of customer 38 (here, less than the second predetermined age).

Determination unit 12a acquires age estimation information (S37b), and requests POS register 22 to scan an ID card that customer 38 possesses by using ID scanner 26 (S51). As a result, a store clerk is notified that scanning is required by ID scanner 26. The notification may be performed to the store clerk by using ID scanner 26, and may be performed by displaying on a display of POS register 22. Thereby, store clerk 39 received the notification requests customer 38 to present an ID card, and when the ID card is scanned, determination unit 12a acquires an actual age (S52) and determines whether or not the acquired actual age is greater than or equal to the first predetermined age (S41b).

Notification unit 12b transmits the determination result to touch panel display 24 (S42b), and transmits the determination result to POS register 22 (S43b).

As such, in a case where the age estimation information is determined to be less than the second predetermined age, the customer may only present an ID card, and thus, it is possible to reduce burden of the customer.

FIG. 5C is a communication sequence diagram illustrating still another example of the operation of the sales support system (store server 10 and sales support terminal 20) according to the exemplary embodiment. The present figure illustrates a communication sequence in a case where collation results of customer 38 do not coincide when face collation is performed, age estimation information is determined to be greater than or equal to the second predetermined age, and there is an answer indicating that customer 38 is under the first predetermined age when age declaration is performed.

Steps S30 to S39, S44, and S45 are the same as the processing illustrated in FIG. 5A, and thus, the same symbols or reference numerals are attached and description thereof will be omitted.

In a case illustrated in the present figure, touch panel display 24 receiving request for age declaration accepts declared age of the customer, and transmits the declared age (here, less than the first predetermined age) to determination unit 12a (S40b).

Determination unit 12a determines customer 38 is under the first predetermined age on the basis of the declared age (S41c).

Notification unit 12b transmits the determination result to touch panel display 24 (S42c), transmits the determination result to POS register 22 (S43c), and touch panel display 24 and display of POS register 22 display the determination result.

FIG. 5D is a communication sequence diagram illustrating still another example of the operation of the sales support system (store server 10 and sales support terminal 20) according to the exemplary embodiment. The present figure illustrates a communication sequence in a case where collation results of customer 38 coincides when face collation is performed.

Steps S30 to S33 and S41a to S45 are the same as the processing illustrated in FIG. 5A, and thus, the same symbols or reference numerals are attached and description thereof will be omitted.

In the case illustrated in the present figure, the face collator obtains collation results (here, coincide). Determination unit 12a determines that customer 38 is older than or equal to the first predetermined age, based on the collation results (S41a).

As such, by registering face feature quantity of a customer, sales of age-restricted merchandise can be performed without obtaining age estimation or age declaration, and thus, it is possible to reduce burden of the customer.

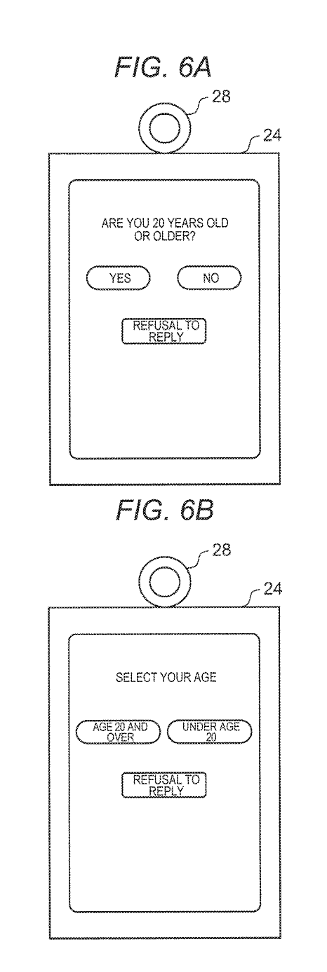

When age verification of S39 is performed, an answer for the age verification from customer 38, that is, age declaration is acquired by displaying an image illustrated in FIG. 6A or 6B.

### [3. Effects or the Like]

As such, store server 10 according to the present exemplary embodiment is a sales support device which supports sales of age-restricted merchandise, and is connected to touch panel display 24 for inputting whether or not a customer is older than or equal to the first predetermined age, and camera 28 for acquiring a face image of the customer. Store server 10 includes face collator 12d which determines whether or not the information coincides with known registration information by using biometric information of a customer, age estimation unit 12c which estimates an age by using the biometric information of the customer, determination unit 12a which determines whether or not the customer is older than or equal to the first predetermined age by using input information input to touch panel display 24, age estimation information indicating an age estimated by age estimation unit 12c, and age information obtained on the basis of face collation results acquired by face collator 12d, and notification unit 12b which notifies a determination result of determination unit 12a, as characteristic configuration element.

Thereby, when sales of age-restricted merchandise are performed, in a case where face collation results of the customer coincide when face collation is performed, determination unit 12a determines that the customer is older than or equal to the first predetermined age, and thus, it is possible to perform age verification of the customer without any burden.

In addition, in a case where the face collation results of the customer do not coincide when face collation is performed, it is determined whether or not the customer is older than or equal to the second predetermined age, based on age estimation information obtained by using biometric information obtained by observing the customer, and in a case where the age estimation information is less than the second predetermined age, presentation of an ID card is requested to the customer without age declaration. Thereby, the customer can complete age verification only by presenting the ID card, and it is possible to reduce burden of the customer.

In addition, in a case where age estimation information acquired by age estimation unit 12c is greater than or equal to the second predetermined age, determination unit 12a does not request the ID card to the customer, and requests age declaration to the customer. Thereby, age verification can be completed only by age declaration, and it is possible to reduce burden of the customer.

### Other Exemplary Embodiments

As described above, a sales support device, a sales support system, a sales support terminal, and a sales support method are described based on exemplary embodiments, but the present invention is not limited to the exemplary embodiments. Various modifications which can be thought by those skilled in the art and are applied to the exemplary embodiments, and another form constructed by combining partial configuration elements of the exemplary embodiments is also included in the scope of the present invention as long as they are not departed from the gist of the present invention.

For example, in the aforementioned exemplary embodiments, store server 10 installed in store 30 functions as a sales support device, but a place (device) in which a function of the sales support device is included is not limited to store server 10, may be mounted in sales support terminal 20 (for example, POS register 22, touch panel display 24, or camera 28), and may be mounted in an external computer such as a cloud server connected to store server 10.

In addition, in the aforementioned exemplary embodiments, peripheral apparatuses (touch panel display 24, ID scanner 26) of sales support terminal 20 are separately configured from POS register 22, but may be configured as one piece. Thereby, sales support terminal 20 becomes compact, and space-saving thereof is achieved.

In addition, in the aforementioned exemplary embodiments, input unit 24b is provided on touch panel display 24, but may be separately provided from touch panel display 24 by a physical button or the like.

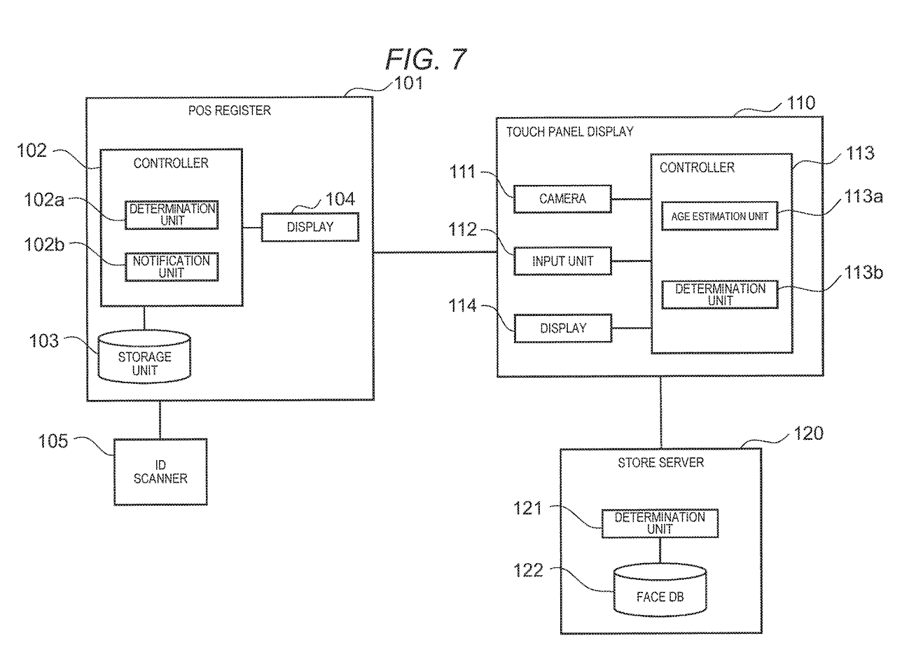

The aforementioned configuration may be, for example, the configuration illustrated in FIG. 7. FIG. 7 is a block diagram illustrating a detailed configuration of a sales support terminal according to another exemplary embodiment. In FIG. 7, a function regarding face collation is excluded, and the function of the store server (sales support device) of FIG. 3 is included in sales support terminal 20. The same symbols or reference numerals will be attached to the same units as in FIG. 3, and description thereof will be omitted.

A sales support system includes POS register 101, touch panel display 110, and store server 120.

POS register 101 includes controller 102, storage unit 103, and display 104. Controller 102 includes determination unit 102a which determines whether or not a customer is older than or equal to a predetermined age, and notification unit 102b which notifies the results. Storage unit 103 stores results or the like of controller 102. Display 104 displays results of reading bar-code information, or results of age declaration received from notification unit 102b.

Touch panel display 110 is a terminal such as a tablet PC, and includes camera 111, input unit 112, controller 113, and display 114. Controller 113 includes age estimation unit 113a which estimates an age of a customer from an image of camera 111, and determination unit 113b which determines whether or not the customer is older than or equal to a predetermined age, based on results (age estimation information) of age estimation unit 113a.

Store server 120 includes face DB 122 which is the same as in FIG. 3, and includes determination unit 121 which determines whether or not face image data acquired by camera 111 coincides with a face image registered in face DB 122.

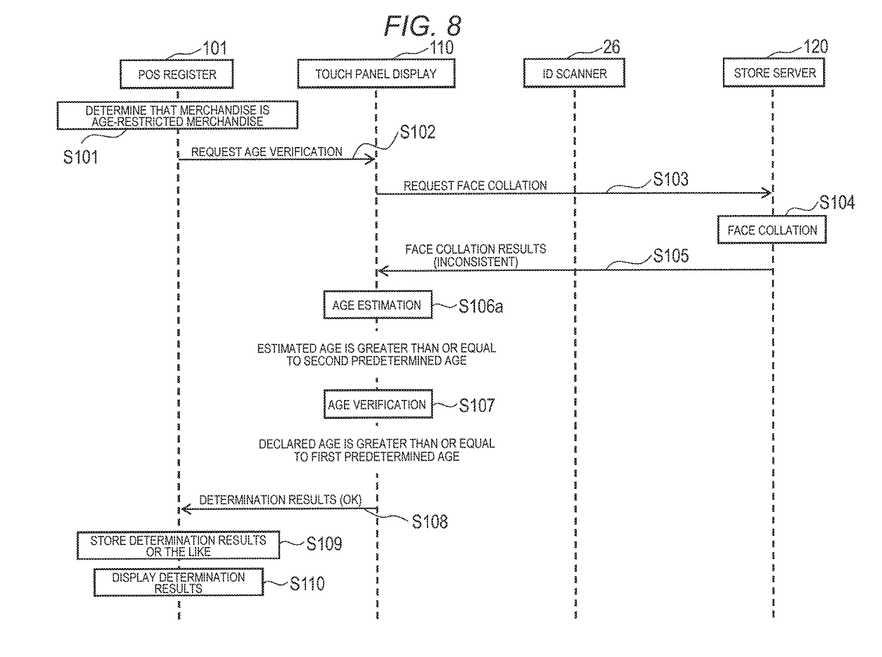

An operation of the sales support system configured as described above will be described by using FIG. 8. FIG. 8 illustrates a communication sequence in a case where collation results of a customer do not coincide when face collation is performed, age estimation information of the customer is determined to be greater than or equal to the second predetermined age, and there is an answer indicating that the customer is older than or equal to the first predetermined age when age declaration is performed. That is, it is the same communication sequence as in the case of FIG. 5A.

POS register 101 reads bar-code information attached to merchandise that a customer intends to purchase, and if the merchandise is determined to be age-restricted merchandise (S101), POS register 101 requests touch panel display 110 to perform age verification (S102).

Touch panel display 110 that receives request for age verification captures an image of a face of the customer by using camera 111, transmits the face image to store server 120, and requests face collation (S103).

As determination unit 121 searches the received face image is registered in face DB 15, store server 120 receiving request for face collation performs face collation (S104). Results of face collation (here do not coincide) is transmitted to the touch panel display (S105).

If touch panel display 110 receives inconsistent face collation, determination unit 113b requests age estimation unit 113a to perform age estimation, and age estimation unit 113a estimates an age, based on the face image (S106a). Here, age estimation unit 113a estimates that the customer is older than or equal to a predetermined age. Determination unit 113b receives information indicating that the customer is older than or equal to the predetermined age, displays display for age verification on display 114, let the customer declare, and determines whether or not a declared age is greater than or equal to the predetermined age, based on the declared age (S107). Determination unit 113b determines to be OK from the declared age (here, greater than or equal to the predetermined age), touch panel display 110 transmits a determination result (OK) to POS register 101 (S108).

POS register 101 stores the determination result from touch panel display 110 (S109), and displays the results on display 104 through notification unit 102b (S110).

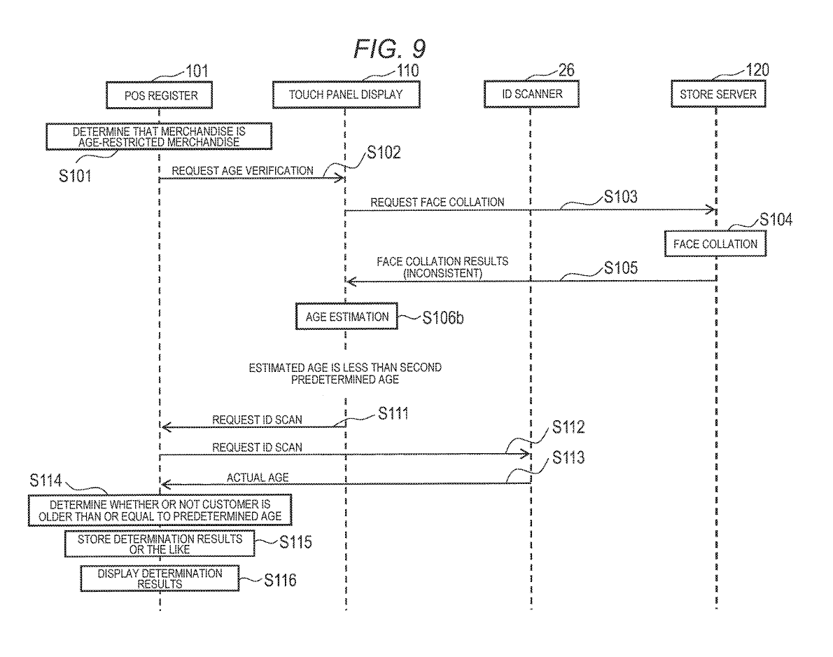

Next, a case where collation results of a customer do not coincide when face collation is performed, age estimation information of the customer is determined to be less than the second predetermined age, and ID scan is performed, will be described by using FIG. 9. FIG. 9 is a communication sequence diagram illustrating an example of the operation of the sales support system according to another exemplary embodiment. The figure is the same case as FIG. 5B described above and steps S101 to S105 are the same as the processing illustrated in FIG. 8, and thus, the same symbols or reference numerals will be attached thereto, and description thereof will be omitted.

If touch panel display 110 receives inconsistent face collation, determination unit 113b requests age estimation unit 113a to perform age estimation, and age estimation unit 113a estimates an age, based on the face image (S106b). Here, age estimation unit 113a estimates that the customer is under the predetermined age. If determination unit 113b receives information indicating that the customer is under the predetermined age, requests POS register 101 to perform ID scan (S111).

POS register 101 receives request of touch panel display 110, requests ID scanner 105 to perform ID scan (S112), and acquires age information (actual age) of an ID card that a customer possesses through ID scanner 105 (S113).

Determination unit 102a of POS register 101 determines whether or not the customer is older than or equal to the second predetermined age, based on the age information (S114), stores the results in storage unit 103 (S115), and displays the results on display 104 through notification unit 102b (S116).

In a case where face collation coincides in step S104, face collation results (coincide) in step S105 are transmitted, determination unit 113b of touch panel display 110 which receives the results determines that the age estimation and the age verification performed in the above steps are not required, and transmits the determination result (OK) to POS register 101.

In addition, in the age verification of step S107 of FIG. 8, in a case where the declared age of the customer is less than the first predetermined age, determination unit 113b determines to be NG, and transmits the determination result (NG) from touch panel display 110 to POS register 101.

Thereby, the same function as in FIG. 3 can be performed by configuring in the same manner as FIG. 7. A function of the face collation may also be included in POS register 101 or touch panel display 110.

In addition, in the aforementioned exemplary embodiments, refusal to age input is accepted, but the age may be always input, and the refusal may not be accepted.

In addition, in the aforementioned exemplary embodiments, POS register 22 distinguishes the age-restricted merchandise by reading a bar code, but a method other than that may be used. For example, a store clerk may watch merchandise and may input information indicating that the merchandise requires age verification into POS register 22.

In addition, the aforementioned exemplary embodiment uses a face image obtained from camera 28 so as to estimate an age of a customer by using biometric information obtained by observing the customer, but is not limited to this, and may estimate an age of a customer from biometric information such as a voice or a fingerprint of physical features or the like which can specify the customer. A method of learning correspondence between feature quantity and an age extracted from biometric information such as a voice or a fingerprint of a customer whose age is distinguished in advance and of estimating an age from the feature quantity extracted from the biometric information such as a voice or a fingerprint of a customer whose age is unknown, based on the learned results may be used as processing of estimating an age of a customer from biometric information such as a voice or a fingerprint of the customer, for example, in the same manner as the age estimation performed from the aforementioned face image. Furthermore, more accurate age verification may be performed by using two or more types of biometric information from a plurality of types of biometric information such as an image, a voice, a fingerprint, and the like. That is, an age can be estimated such that a user is not conscious of an operation other than an operation of age verification such as presenting an ID card and the user is not conscious of an operation other than an input operation such as age verification of camera 28, as the method of age verification.

In addition, if a person can specify, the aforementioned other biometric information may also be used for the face collation.

In addition, in the aforementioned exemplary embodiments, determination unit 12a, notification unit 12b, age estimation unit 12c, and face collator 12d are provided in store server 10, but may be provided in an external computer device such as POS register 22, touch panel display 24, camera 28, or the aforementioned cloud server. In addition, in a case where store server 10 is in an aisle in the store, an ID scanner may be connected to store server 10. Age estimation unit 12c and face collator 12d may be included in camera 28.

In addition, in the aforementioned exemplary embodiments, time specified by store server 10 is used as current time stored in storage unit 14, but instead of this or in addition to this, time when touch panel display 24 receives an answer from a customer with respect to absolute value may be specified, the specified time and input information may be transmitted to store server 10 to be stored in storage unit 14 of store server 10. In the same manner, time when camera 28 captures an image of the customer may be specified, the specified time and age estimation information may be transmitted to store server 10 to be stored in storage unit 14 of store server 10, time when an ID scanner 26 reads information from an ID card of the customer may be specified, and the specified time and actual age may be transmitted to store server 10 to be stored in storage unit 14 of store server 10. Thereby, accurate times when the age estimation information and actual age are respectively acquired are stored.

In addition, statistical data such as data indicating a degree of coincidence of input results of a customer and results of age estimation, based on determination result or the like stored in store server 10 may be output. In addition, the determination result of a plurality of store servers 10 may be summarized by a cloud server or the like outside the store and may be output as statistical data.

In addition, in the aforementioned exemplary embodiments, POS register 22 receives determination result and displays the results through notification unit 12b, but a sound, light (lamp) or the like may be used as an output form in addition to display.

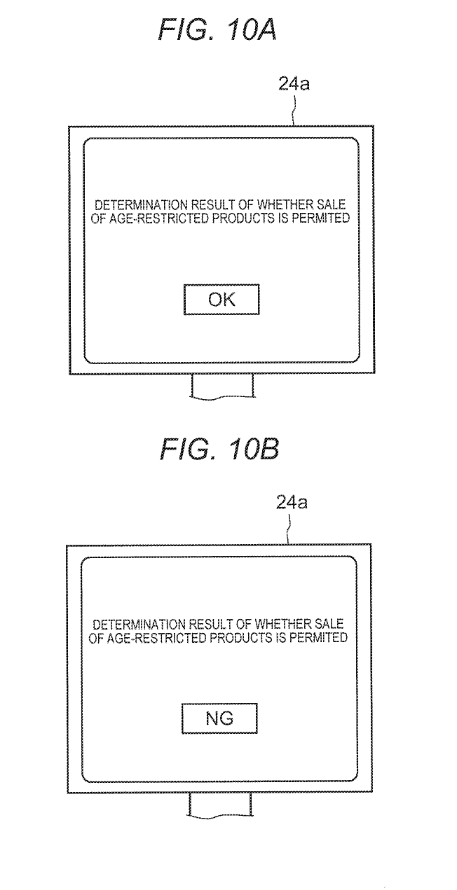

In addition, in the aforementioned exemplary embodiments, “OK” and “NG” are used as determination result, but information necessary for notification, for example, display data and the like illustrated in FIGS. 10A and 10B may be used.

In addition, in the aforementioned exemplary embodiments, the sales support method illustrated in FIG. 4 can be realized as a program executed by a computer that store server 10 includes. The program can also be distributed in a state of being recorded in a computer readable recording medium such as a DVD, or be distributed through a communication network such as Internet.

As such, the exemplary embodiments are described as examples of technique according to the present disclosure. Accordingly, accompanying drawings and detailed description are provided.

Hence, configuration elements described in the accompanying drawings and the detailed description can also include not only configuration elements essential for solving problems, but also configuration elements inessential for solving the problems so as to exemplify the technique. Accordingly, the inessential configuration elements do not have to be directly certified as essential configuration elements, based on the fact that the inessential configuration elements are described in the accompanying drawings and the detailed description.

In addition, since the aforementioned exemplary embodiments exemplify techniques according to the present disclosure, various modifications, replacements, additions, omissions, or the like can be made within the scope of claims or within a range of equivalents thereof.

The present disclosure can be applied to a sales support device and a sales support system which can perform age verification without burdening a customer when sales of age-restricted merchandise are performed. Specifically, the present disclosure can be applied to a POS register, a store server, a cloud server, and the like connected to a tablet PC and a digital camera.

What is claimed is:

1. A sales support method which supports sales of age-restricted merchandise, the method comprising:
acquiring age estimation information that is information which is obtained by estimating an age of a customer by using biometric information which is obtained by observing the customer;
acquiring information that is input by the customer as age information of the customer in a case where the age estimation information is greater than or equal to a second predetermined age, and acquiring information that is based on a medium that the customer possesses as the age information of the customer in a case where the age estimation information is less than the second predetermined age; and
determining whether the customer is older than or equal to a first predetermined age or under the first predetermined age, based on the age information of the customer and notifying a determination result.

2. The sales support method of claim 1, further comprising:
determining whether or not the biometric information coincides with registration information which is registered in advance,
wherein, in a case the biometric information does not coincide with the registration information the age estimation information is acquired.

3. The sales support method of claim 1, wherein the biometric information is an image obtained by capturing the customer.

4. The sales support method of claim 3, wherein the biometric information is information on a face.

5. The sales support method of claims 1 wherein it is determined whether or not a customer is registered in advance, by using the biometric information before the age estimation information is acquired.

6. The sales support method of claims 1, wherein the age estimation information is acquired in a case where merchandise is the age-restricted merchandise.

7. A sales support system which supports sales of age-restricted merchandise, the system comprising:
an input unit for inputting whether a customer is older than or equal to a first predetermined age or under the first predetermined age;
an age estimation unit that estimates an age of the customer by using biometric information which is obtained by observing the customer;
a determination unit that acquires age information of the customer on the basis of the age estimation information and determines whether the customer is older than or equal to the first predetermined age or under the first predetermined age on the basis of the age information of the customer; and
a notification unit that notifies a determination result of the determination unit,
wherein the determination unit acquires information that is input by the customer as the age information of the customer in a case where the age estimation information is greater than or equal to a second predetermined age, and acquires the age information of the customer on the basis of a medium that the customer possesses in a case where the age estimation information is less than the second predetermined age.
